(19) United States
(12) Patent Application Publication
(10) Pub. No.: US 2013/0171412 A1
(43) Pub. Date: Jul. 4, 2013

(54) Method and system for producing sheet- or plate-shaped objects

(71) Applicant: Li-Tec Battery GmbH, Kamenz (DE)

(72) Inventors: Tim Schaefer, Harztor (DE); Steffen Legner, Ellwangen (DE)

(73) Assignee: LI-TEC BATTERY GMBH, Kamenz (DE)

(21) Appl. No.: 13/705,163

(22) Filed: Dec. 4, 2012

Related U.S. Application Data
(60) Provisional application No. 61/566,719, filed on Dec. 5, 2011.

(30) Foreign Application Priority Data
Dec. 5, 2011 (DE) 102011120278.5

(51) Int. Cl. H01M 4/04; B29C 67/00

(52) U.S. Cl. CPC H01M 4/04; B29C 67/0011
USPC 428/141; 29/527.1; 264/400; 425/174.4

(57) ABSTRACT

A system for producing sheet- or plate-shaped objects having at least one active surface, in particular for producing electrodes for constructing an electrochemical energy storage, preferably configured for use in a motor vehicle, or parts of such electrodes, is described, wherein the sheet- or plate-shaped objects have a first object side and a second object side opposite the first object side, and wherein the production system has a first radiating apparatus, particularly a first laser apparatus, which is arranged and configured in such a manner that it can change the roughness of the active surface on the first object side of the electrode. Furthermore, a method for producing sheet- or plate-shaped objects is described.

The present application claims the benefit of U.S. Provisional Patent Application Ser. No. 61/566,719, filed on Dec. 5, 2011 and which is incorporated herein by reference in its entirety. The present application also claims priority to German Patent Application No. 10 2011 120 278.5, filed on Dec. 5, 2011 and which is incorporated herein by reference in its entirety.

The present invention relates to a method and a system for producing sheet- or plate-shaped objects, particularly for producing electrodes for constructing an electrochemical energy store or parts of such electrodes.

Batteries (primary storages) and rechargeable batteries (secondary storages) are known as electrochemical energy storages, which are constructed from one or a plurality of storage cells, in which, when a charging current is applied, electrical energy is converted in an electrochemical charging reaction between a cathode and an anode in or between an electrolyte into chemical energy and thus stored and in which, when an electrical consumer is connected, chemical energy is converted in an electrochemical discharging reaction into electrical energy. In this case, primary storages are generally only charged once and discarded following the discharge thereof, whilst secondary storages allow a plurality of (from several 100 to more than 10,000) cycles of charging and discharging. In this context, it is to be noted that in particular in the automotive sector, rechargeable batteries are also designated as batteries.

The electrodes are required in very great quantities, for which reason there is a need for high-quality, effective and cost-effective assembly methods.

It is therefore an object of the present invention to create an improved method and an improved system for producing sheet- or plate-shaped objects.

This object is achieved by means of a method for producing sheet- or plate-shaped objects according to claim 1 or a system for producing sheet- or plate-shaped objects according to claim 15 or according to a sheet- or plate-shaped object according to claim 24. Advantageous configurations and developments of the invention are the subject of the dependent claims.

This object is achieved in the case of a method for producing sheet- or plate-shaped objects having at least one active surface, in particular for producing electrodes for constructing an electrochemical energy store, preferably configured for use in a motor vehicle, or parts of such electrodes, wherein the sheet- or plate-shaped objects have a first object side and a second object side opposite the first object side, in that the production method has the step: changing the roughness of the active surface on the first object side by means of a first radiating apparatus, particularly a first laser apparatus. An advantage of the method according to the invention lies in the fact that with the change of the roughness of the surface, the cycle stability of the cells can be improved. Another advantage lies in the fact that the boundary surfaces, which otherwise are closed during calendaring steps, can be left open. A further advantage lies in the fact that the capacitance of the cells can be increased. An additional advantage lies in the fact that by means of the enlargement of the surface, a better wetting can be achieved with the electrolyte. An further advantage lies in the fact that a shortening of the filling times with the electrolyte can be achieved. Another advantage lies in the fact that the discharge rates can be increased. An additional advantage lies in the fact that the enlargement of the surface allows higher current intensities.

An “electrochemical energy storage” should be understood in the present document to mean any type of energy storage from which electrical energy can be drawn, wherein an electrochemical reaction proceeds in the interior of the energy storage. The term comprises energy storages of all types, particularly primary batteries and secondary batteries. The electrochemical energy storage apparatus has at least one electrochemical cell, preferably a plurality of electrochemical cells. The plurality of electrochemical cells can be connected in parallel for storing a relatively large charge quantity or, to achieve a desired operating voltage, be connected in series or form a combination of parallel and series connection.

An “electrochemical cell” is in this case to be understood to mean an apparatus which is used for outputting electrical energy, wherein the energy is stored in chemical form. In the case of rechargeable secondary batteries, the cell is also constructed to receive electrical energy, convert the same into chemical energy and store the same. The shape (i.e. in particular the size and the geometry) of an electrochemical cell can be chosen as a function of the available space. Preferably, the electrochemical cell is essentially prismatically or cylindrically constructed. The present invention can be used in an advantageous manner in particular for electrochemical cells which are designated as pouch cells or coffee bag cells, without the electrochemical cell of the present invention being limited to this use.

An electrochemical cell of this type usually has an electrode stack which is enveloped at least to some extent by a casing. In this context, an “electrode stack” should be understood to mean an arrangement made up of at least two electrodes and an electrolyte arranged therebetween. The electrolyte can to some extent be accommodated by a separator, wherein the separator then separates the electrodes. Preferably, the electrode stack has a plurality of layers of electrodes and separators, wherein the electrodes of the same polarity are in each case preferably electrically connected to one another, particularly connected in parallel. The electrodes are for example constructed in a plate-shaped or film-like manner and are preferably arranged essentially parallel to one another (prismatic energy storage cells). The electrode stack can also be wound and possess an essentially cylindrical shape (cylindrical energy storage cells). The term “electrode stack” should also comprise electrode coils of this type. The electrode stack can have lithium or another alkali metal also in ionic form.

In the context of this invention a “sheet- or plate-shaped object” should be understood to mean an essentially flat object, preferably a thin flat object. A flat object is in this case an object, the dimensions of which are substantially smaller in a direction perpendicular to the surface thereof (also designated as thickness direction) than the dimensions of the largest paths which lie completely within the surface. The first and the second object sides in each case form the surface of a flat object of this type, wherein the first and the second object sides preferably run essentially parallel to one another without the invention being limited to this design variant. The side surface which connects the first and the second object sides to one another determines the thickness dimension of the flat object. The side surface in this case preferably runs essentially parallel to the first and to the second object sides, without the invention being limited to this design variant. The first and second object sides can fundamentally assume any desired shapes, preferably the first and the second object sides are chosen to be essentially rectangular in each case; in this case, the object has four side surfaces in total, wherein adjacent side surfaces are arranged essentially at right angles to one another. The thickness dimension of the objects is fundamentally arbitrary, it preferably ranges from film thickness to plate thickness. The first object side of the object can also be termed object upper side and the second object side of the object can also be termed object underside or vice versa.

Preferably, the production method has the step: removing active material on the active surface on the first object side of the electrode. An advantage of this configuration lies in the fact that a two-dimensional lithium deposition can be reduced and that the growth in thickness of the electrochemical cell reduces towards the end of the service life.

Preferably in the method, the step of removing material on the first object side of the electrode is carried out by means of laser scanning.

Preferably in the method, the step of removing material on the first object side of the electrode is carried out in such a manner that on the first object side of the electrode a first electrode surface structure is realised, which is adapted to a first separator surface structure of an opposite first separator surface of a separator in the assembled state of the first object side of the electrode. An advantage of this configuration lies in the fact that by adapting the surface structure of the electrode to the surface structure of the separator, the internal resistance of the electrochemical cell can be improved. A further advantage of this configuration lies in the fact that an improved binding of the active surfaces can be achieved during cyclising. A further advantage of this configuration lies in the fact that an increased service life or an increased number of cycles can be achieved.

Preferably the production method has the step: detecting the first separator surface structure of the first opposite separator surface in the assembled state of the first object side of the electrode, wherein the step of changing the roughness of the active surface on the first object side is preferably carried out depending on the detected first separator surface structure.

Preferably, the production method has at least one of the following steps: applying the first separator surface structure of the first opposite separator surface in the assembled state of the first object side of the electrode before the step of changing the roughness of the active surface on the first object side of the electrode or applying the first separator surface structure of the first opposite separator surface in the assembled state of the first object side of the electrode after the step of changing the roughness of the active surface on the first object side of the electrode.

Preferably, the production method has the step: changing the roughness of the active surface on the second object side by means of a second radiating apparatus, particularly a second laser apparatus.

Preferably, the production method has the step: removing of active material on the active surface on the second object side of the electrode.

Preferably in the method, the step of removing material on the second object side of the electrode is carried out by means of laser scanning.

Preferably in the method, the step of removing material on the second object side of the electrode is carried out in such a manner that on the second object side of the electrode a second electrode surface structure is realised, which is adapted to a second separator surface structure of an opposite second separator surface of a separator in the assembled state of the second object side of the electrode.

Preferably, the production method has the step: detecting the second separator surface structure of the second opposite separator surface in the assembled state of the second object side of the electrode, wherein the step of changing the roughness of the active surface on the second object side is preferably carried out depending on the detected second separator surface structure.

Preferably, the production method has at least one of the following steps: applying the second separator surface structure of the second opposite separator surface in the assembled state of the second object side of the electrode before the step of changing the roughness of the active surface on the second object side of the electrode or applying the second separator surface structure of the second opposite separator surface in the assembled state of the second object side of the electrode after the step of changing the roughness of the active surface on the second object side of the electrode.

Preferably in the method, the first and/or the laser apparatus has a laser, preferably a carbon dioxide laser; with at least one of the following parameters: a focal spot size smaller than 100 μm and/or a working wavelength smaller than 1070 nm.

This method is additionally suitable for continuous production methods in continuous production lines. The method is also suitable for producing a very large number of objects. Thus, it offers particular advantages for producing electrodes or separators for constructing electrochemical energy storages.

The first and the second radiating apparatuses are preferably two different apparatuses, which are separated from one another, alternatively they may however also be one and the same apparatus.

Furthermore, in the production method for at least one component of the electrode, a material can be selected from a group which comprises: LiCoO₂, LiNiO₂, LiFePO₄, Li₄Ti₅O₁₂, Li[NiₓCo_{1-x-y}Mn_{y}]O₂, LiNi₁₋ₓCoₓO₂, Li[NiₓCo_{1-x-y}Al_{y}]O₂, SnO₂ or LaMn₂O₄.

The object of the present invention is achieved in the case of a system for producing sheet- or plate-shaped objects having at least one active surface, in particular for producing electrodes for constructing an electrochemical energy storage or parts of such electrodes, wherein the sheet- or plate-shaped objects have a first object side and a second object side opposite the first object side, in that the production system has a first radiating apparatus, particularly a first laser apparatus, which is arranged and configured in such a manner that it can change the roughness of the active surface on the first object side of the electrode.

Preferably, in the production system the first laser apparatus is arranged and configured for removing active material on the active surface of the first object side of the electrode by means of laser scanning.

Preferably, the production system has a first detection unit, which is arranged and configured for detecting a first separator surface structure of a first separator surface.

Preferably, the production system has a first separator surface structuring apparatus, which is arranged and configured for applying a first separator surface structure on the first separator surface.

Preferably, the production method has a second radiating apparatus, in particular a second laser apparatus, which is arranged and configured in such a manner that it can change the roughness of the active surface on the second object side of the electrode.

Preferably, in the production system the second laser apparatus is arranged and configured for removing active material on the active surface of the second object side of the electrode by means of laser scanning.

Preferably, the production system has a second detection unit, which is arranged and configured for detecting a second separator surface structure of a second separator surface.

Preferably, the production system has a second separator surface structuring apparatus, which is arranged and configured for applying a second separator surface structure on the second separator surface.

Preferably, in the production system, the first and/or the second laser apparatus has a laser, preferably a carbon dioxide laser; with at least one of the following parameters: a focal spot size smaller than 100 μm and/or a working wavelength smaller than 1070 nm.

With respect to the advantages of this production system and the terms used, the statements made above in connection with the production method according to the invention apply correspondingly.

The present invention also relates to an electric cell for an electrochemical energy storage apparatus with electrodes which has been produced in accordance with a previously mentioned production method and/or has been produced with the aid of a previously mentioned production system.

According to a further aspect of the present invention, this object is achieved in the case of a sheet- or plate-shaped object, in particular in the case of an electrode for constructing an electrochemical energy storage, preferably configured for use in a motor vehicle, or parts of such electrodes, wherein the sheet- or plate-shaped object has a first object side and a second object side opposite the first object side, in that the sheet- or plate-shaped object has been produced with one of the above-mentioned methods and/or has been produced with one of the above-mentioned production systems.

Further advantages, features and application possibilities of the present invention can be seen from the following description in connection with the drawings. In the figures:

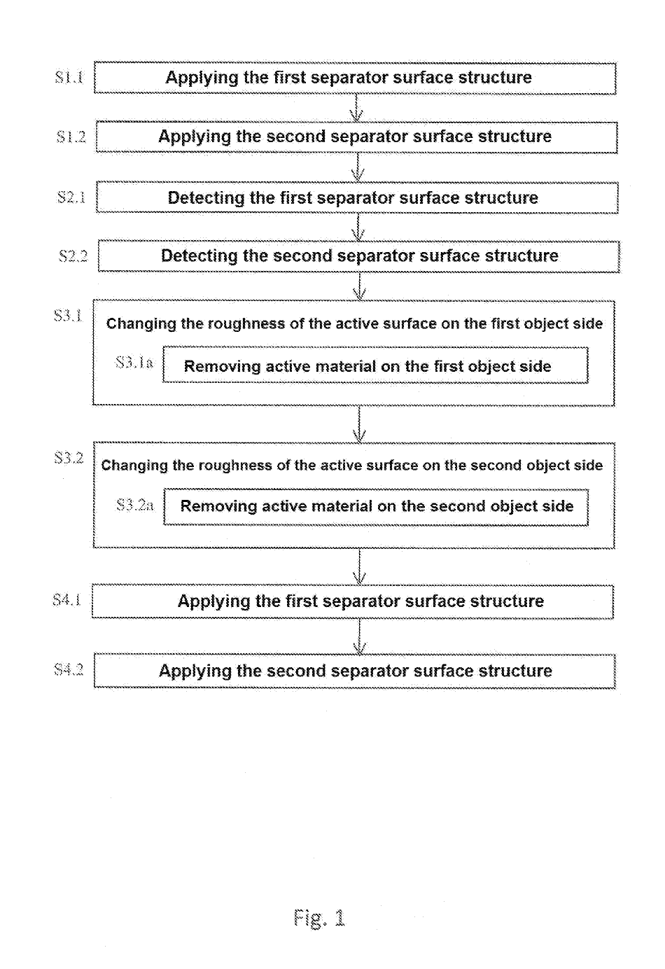

FIG. 1 shows a flow chart of an embodiment for a production method according to the present invention,

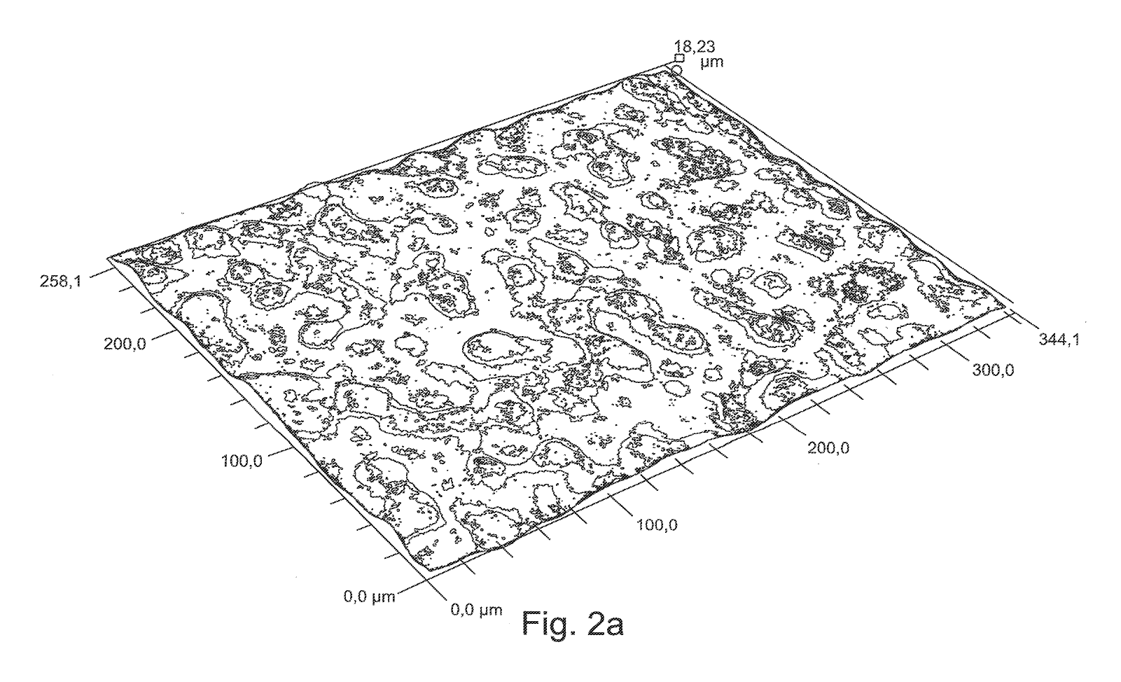

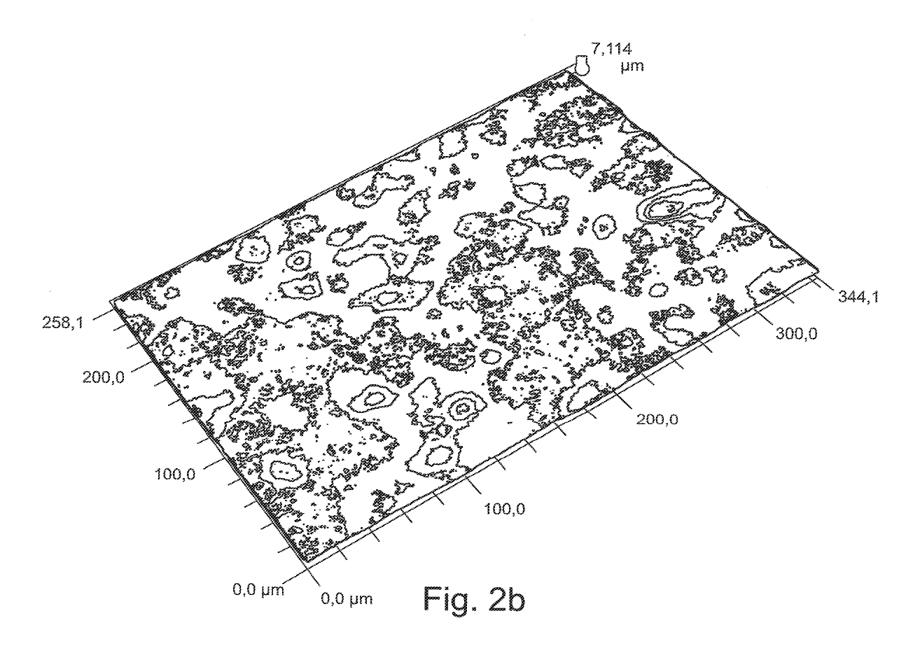

FIG. 2a shows a plan view onto an active surface of an electrode treated according to the invention by means of scanning tunneling microscopy,

FIG. 2b shows a plan view onto an untreated active surface of an electrode by means of scanning tunneling microscopy,

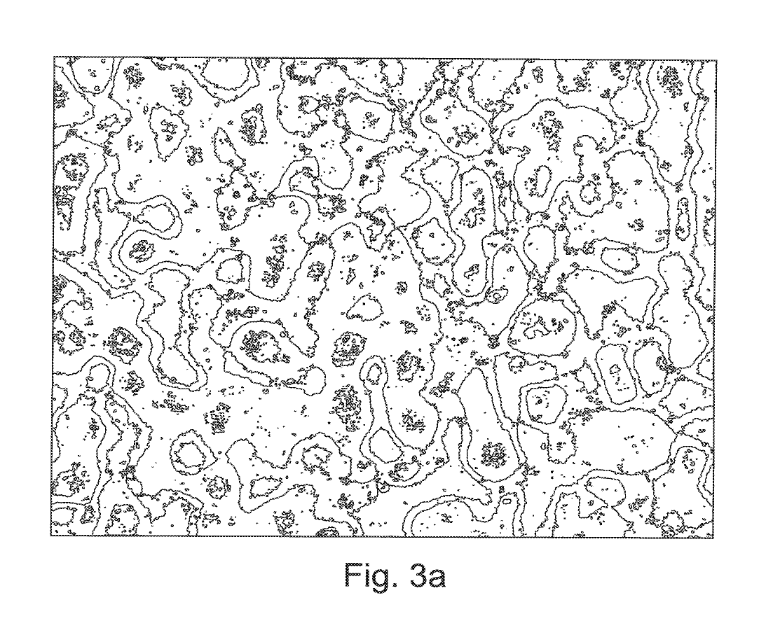

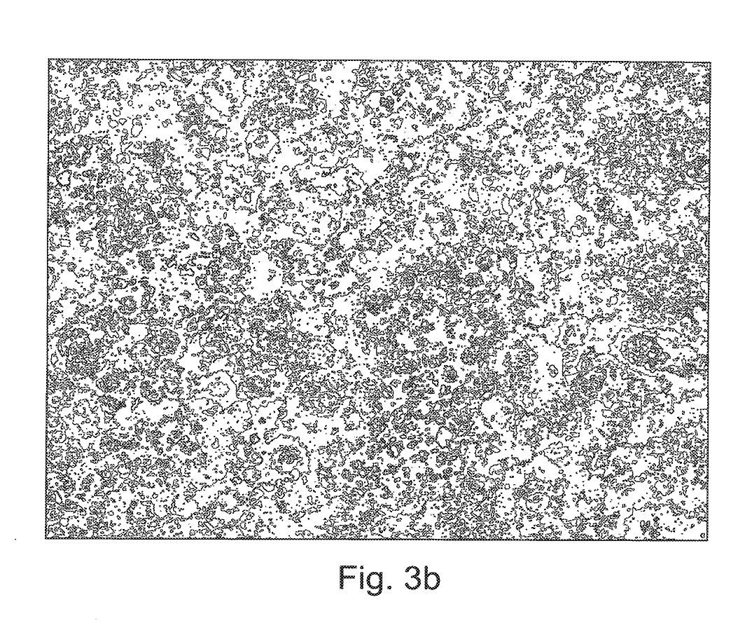

FIG. 3a shows a perspective view onto an active surface of an electrode treated according to the invention by means of scanning tunneling microscopy, and

FIG. 3b shows a perspective view onto an untreated active surface of an electrode by means of scanning tunneling microscopy.

The present invention is explained in the following on the basis of examples of the production of electrodes for an electrochemical energy store.

FIG. 1 shows an embodiment for a production method according to the present invention. In the case of pre-products of electrodes having a first and a second object side, which e.g. have been produced by means of calendaring, in a step S3.1 changing the roughness of the active surface on the first object side is carried out by means of a first radiating apparatus, particularly a first laser apparatus. Preferably, in a step S3.2 changing the roughness of the active surface on the second object side is carried out by means of a second radiating apparatus, particularly a second laser apparatus, wherein the first and second radiating apparatuses are preferably two different apparatuses, which are separated from one another. Alternatively, they may also be one and the same apparatus, however. The steps S3.1 of changing the roughness of the active surface on the first object side and S3.2 of changing the roughness of the active surface on the second object side can have a step S3.1a of removing active material on the active surface on the first object side of the electrode or a step S3.2a of removing active material on the active surface on the second object side of the electrode. According to a preferred embodiment illustrated in FIG. 1, the method has prior to that both a step S2.1 of detecting the first separator surface structure of the first opposite separator surface in the assembled state of the first object side of the electrode, wherein preferably the step S3.1 of changing the roughness of the active surface on the first object side is carried out depending on the detected first separator surface structure, and a step S2.2 of detecting the second separator surface structure of the second opposite separator surface in the assembled state of the second object side of the electrode, wherein preferably the step S3.2 of changing the roughness of the active surface on the second object side is carried out depending on the detected second separator surface structure.

According to a further preferred embodiment, the method can have a step S1.1 of applying a first separator surface structure of the first opposite separator surface in the assembled state of the first object side of the electrode before the step S3.1 of changing the roughness of the active surface on the first object side of the electrode or a step S1.2 of applying a second separator surface structure of the second opposite separator surface in the assembled state of the second object side of the electrode before the step S3.2 of changing the roughness of the active surface on the second object side of the electrode.

Alternatively and/or additionally, the method can have a step S4.1 of applying a first separator surface structure of the first opposite separator surface in the assembled state of the first object side of the electrode after the step S3.1 of changing the roughness of the active surface on the first object side of the electrode or a step S4.2 of applying the second separator surface structure of the second opposite separator surface in the assembled state of the second object side of the electrode after the step S3.2 of changing the roughness of the active surface on the second object side of the electrode.

FIGS. 2a and 3a show a plan view by means of scanning tunneling microscopy onto an active surface treated according to the invention or a perspective view by means of scanning tunneling microscopy onto an active surface treated according to the invention of an electrode, whilst the FIGS. 2b and 3b show a plan view by means of scanning tunneling microscopy onto an untreated active surface of an electrode or a perspective view onto an untreated active surface of an electrode by means of scanning tunneling microscopy. As can be seen from the comparison of the figures for the active surfaces treated according to the invention with the figures for the untreated active surfaces, the treated electrode surfaces have an improved roughening with a finer surface structure and thus an enlargement of the active surface, as a result of which the wetting with electrolytes can be improved and a lengthening of the service life can be achieved. Furthermore, during the production of the electrochemical energy storages, the filling times with the electrolyte can be reduced.

### REFERENCE LIST

S1.1 Applying the first separator surface structure
S1.2 Applying the second separator surface structure
S2.1 Detecting the first separator surface structure
S2.2 Detecting the second separator surface structure
S3.1 Changing the roughness of the active surface on the first object side
S3.1a Removing active material on the active surface on the first object side
S3.2 Changing the roughness of the active surface on the second object side
S3.2a Removing active material on the active surface on the second object side
S4.1 Applying the first separator surface structure
S4.2 Applying the second separator surface structure

1. A method for producing sheet- or plate-shaped objects having at least one active surface, in particular for producing electrodes for constructing an electrochemical energy storage, preferably configured for use in a motor vehicle, or parts of such electrodes, wherein the sheet- or plate-shaped objects have a first object side and a second object side opposite the first object side, wherein the production method comprises the step:
(S3.1) changing the roughness of the active surface on the first object side by means of a first radiating apparatus, particularly a first laser apparatus.

2. The method according to claim 1, wherein the production method has the step:
(S3.1a) removing active material on the active surface on the first object side of the electrode.

3. The method according to claim 2, wherein the step (S3.1a) of removing material on the first object side of the electrode is carried out by means of laser scanning.

4. The method according to claim 1, wherein the step (S3.1a) of removing material on the first object side of the electrode is carried out in such a manner that on the first object side of the electrode a first electrode surface structure is realised, which is adapted to a first separator surface structure of an opposite first separator surface of a separator in the assembled state of the first object side of the electrode.

5. The method according to claim 4, wherein the production method has the step:
(S2.1) detecting the first separator surface structure of the first opposite separator surface in the assembled state of the first object side of the electrode, wherein
preferably the step (S3.1) of changing the roughness of the active surface on the first object side is carried out depending on the detected first separator surface structure.

6. The method according to claim 4, wherein the production method has at least one of the following steps:
(S1.1) applying the first separator surface structure of the first opposite separator surface in the assembled state of the first object side of the electrode before the step (S3.1) of changing the roughness of the active surface on the first object side of the electrode or
(S4.1) applying the first separator surface structure of the first opposite separator surface in the assembled state of the first object side of the electrode after the step (S3.1) of changing the roughness of the active surface on the first object side of the electrode.

7. The method according to claim 1, wherein the production method has the step:
(S3.2) changing the roughness of the active surface on the second object side by means of a second radiating apparatus, particularly a second laser apparatus.

8. The method according to claim 7, wherein the production method has the step:
(S3.2a) removing active material on the active surface on the second object side of the electrode.

9. The method according to claim 8, wherein the step (S3.2a) of removing material on the second object side of the electrode is carried out by means of laser scanning.

10. The method according to claim 7, wherein the step (S3.2a) of removing material on the second object side of the electrode is carried out in such a manner that on the second object side of the electrode a second electrode surface structure is realised, which is adapted to a second separator surface structure of an opposite second separator surface of a separator in the assembled state of the second object side of the electrode.

11. The method according to claim 10, wherein the production method has the step:
(S2.2) detecting the second separator surface structure of the second opposite separator surface in the assembled state of the second object side of the electrode, wherein
preferably the step (S3.2) of changing the roughness of the active surface on the second object side is carried out depending on the detected second separator surface structure.

12. The method according to claim 10, wherein the production method has at least one of the following steps:
(S1.2) applying the second separator surface structure of the second opposite separator surface in the assembled state of the second object side of the electrode before the step (S3.2) of changing the roughness of the active surface on the second object side of the electrode or
(S4.2) applying the second separator surface structure of the second opposite separator surface in the assembled state of the second object side of the electrode after the step (S3.2) of changing the roughness of the active surface on the second object side of the electrode.

13. The method according to claim 1, wherein the first and/or the second laser apparatus has a laser, preferably a carbon dioxide laser; with at least one of the following parameters:
a focal spot size smaller than 100 μm or
a working wavelength smaller than 1070 nm.

14. The method according to claim 1, wherein for at least one component of the electrode, material is selected from a group which comprises: LiCoO₂, LiNiO₂, LiFePO₄, Li₄Ti₅O₁₂, Li[NiₓCo_{1-x-y}Mn_{y}]O₂, LiNi₁₋ₓCoₓO₂, Li[NiₓCo_{1-x-y}Al_{y}]O₂, SnO₂ or LaMn₂O₄.

15. A system for producing sheet- or plate-shaped objects having at least one active surface, in particular for producing electrodes for constructing an electrochemical energy storage, preferably configured for use in a motor vehicle, or parts of such electrodes, wherein the sheet- or plate-shaped objects have a first object side and a second object side opposite the first object side, wherein the production system has a first radiating apparatus, particularly a first laser apparatus, which is arranged and configured in such a manner that it can change the roughness of the active surface on the first object side of the electrode.

16. The production system according to claim 15, wherein the first laser apparatus is arranged and configured for removing active material on the active surface of the first object side of the electrode by means of laser scanning.

17. The production system according to claim 15, further comprising a first detection unit, which is arranged and configured for detecting a first separator surface structure of a first separator surface.

18. The production system according claim 15, further comprising a first separator surface structuring apparatus, which is arranged and configured for applying a first separator surface structure on the first separator surface.

19. The production method according to claim 15, further comprising a second radiating apparatus, in particular a second laser apparatus, which is arranged and configured in such a manner that it can change the roughness of the active surface on the second object side of the electrode.

20. The production system according to claim 19, wherein the second laser apparatus is arranged and configured for removing active material on the active surface of the second object side of the electrode by means of laser scanning.

21. The production system according to claim 19, further comprising a second detection unit, which is arranged and configured for detecting a second separator surface structure of a second separator surface.

22. The production system according to claim 19, further comprising a second separator surface structuring apparatus, which is arranged and configured for applying a second separator surface structure on the second separator surface.

23. The production system according to claim 15, wherein the first and/or the second laser apparatus has a laser, preferably a carbon dioxide laser; with at least one of the following parameters:
a focal spot size smaller than 100 μm or
a working wavelength smaller than 1070 nm.

24. A sheet- or plate-shaped object, in particular an electrode for constructing an electrochemical energy storage, preferably configured for use in a motor vehicle, or parts of such electrodes, wherein the sheet- or plate-shaped object has a first object side and a second object side opposite the first object side, wherein the sheet- or plate-shaped object has been produced with a method according to claim 1.
